(19) United States
(12) Patent Application Publication
(10) Pub. No.: US 2026/0352324 A1
(43) Pub. Date: Nov. 5, 2026

(54) METHOD AND SYSTEM FOR POSITIONING

(71) Applicant: VAASAN YLIOPISTO, Vaasa (FI)

(72) Inventors: Mohammed Salem ELMUSRATI, Vaasa (FI); Mahmoud Essam Mohamed Soliman ELSANHOURY, Vaasa (FI); Janne Tapio KOLJONEN, Vaasa (FI); Heidi KUUSNIEMI, Vaasa (FI)

(21) Appl. No.: 19/483,809

(22) PCT Filed: May 10, 2024
(86) PCT No.: PCT/FI2024/050223

§ 371 Date: Nov. 12, 2025

(30) Foreign Application Priority Data
May 12, 2023 (FI) 20235545

(51) Int. Cl. H04B 7/185; G01S 19/25

(52) U.S. Cl. CPC H04B 7/18586; G01S 19/258

(57) ABSTRACT

The invention relates to a method and system for positioning. The method comprises receiving two or more satellite beam signals from one or more satellites in a user terminal, identifying the one or more satellites from which the two or more satellite beam signals are received based on unique beam identifiers, acquiring satellite-to-earth-geometry data of the identified one or more satellites, calculating on-earth footprints of the received two or more satellite beam signals based on the satellite-to-earth-geometry data of the identified one or more satellites, and calculating position of the user terminal based on the on-earth footprints of the received two or more satellite beam signals.

### FIELD OF THE INVENTION

The present invention relates to a method for positioning and more particularly to a method according to preamble of claim 1. The method further relates to a system for positioning and more particularly to a system according to preamble of claim 11.

### BACKGROUND OF THE INVENTION

In the prior art large scale positioning systems are based on global navigation satellite systems (GNSS) and signals received from the GNSS satellites. The GNSS satellite broadcasts a signal that contains orbital data and the precise time the signal was transmitted. Orbital data includes a precise ephemeris of the satellite. The ephemeris is transmitted together with a timing reference. The satellite uses an atomic clock to maintain synchronization of all the satellites in the system. The receiver compares the time of broadcast encoded in the transmission of multiple different satellites, measuring the time-of-flight to each satellite for calculating the distance between the receiver and the satellites for further calculating the position. These measurements and calculations require high precision and are complex to perform requiring heavy computational power.

The GNSS comprise usually Medium Earth Orbit satellites at altitudes between 2000 to 35000 km. The high altitudes cause signa degradation and path losses In GNSS there are a restricted number of separate satellites as launching Medium Earth Orbit satellites is complicated and expensive. One of the problems associated with the prior art is that the GNSS positioning requires multiple satellites to be available at the same time. The restricted number of satellites causes blind spots and interruptions in positioning. Further, the GNSS based positioning is usually also restricted indoors and other places having interfered signal path.

### BRIEF DESCRIPTION OF THE INVENTION

An object of the present invention is to provide a method and a system so as to solve or at least alleviate the prior art disadvantages.

The scope of protection sought for various embodiments is defined by the independent claims. Dependent claims define further embodiments included in the scope of protection. Exemplary embodiments, if any, that do not fall into any scope of protection defined in the claims, are to be considered as examples useful for understanding the cope of protection.

The preferred embodiments of the invention are disclosed in the dependent claims.

In the context of the present application the terms “based on” and “by utilizing” are used interchangeably. Both terms mean the mentioned information or data is used for certain purpose. These terms are not used as exclusive meaning the also other information or data may be used together with the mentioned information or data.

The invention is based on the idea of providing a method for positioning. The method comprises receiving one or more satellite beam signals from one or more satellites simultaneously in a user terminal, each of the received one or more satellite beam signals comprising a unique beam identifier, identifying the one or more satellites from which the one or more satellite beam signals are received based on the unique beam identifiers, acquiring satellite-to-earth-geometry data of the identified one or more satellites, the satellite-to-earth-geometry data comprising satellite location and direction information in time-domain, calculating on-earth footprints of the received one or more satellite beam signals based on the satellite-to-earth-geometry data of the identified one or more satellites, the on-earth footprints comprising location information of the on-earth footprints, and calculating position of the user terminal based on the on-earth footprints of the received one or more satellite beam signals, the position of the user terminal being defined in the calculated on-earth footprints of the received one or more satellite beam signals.

Accordingly, in the present invention the position of the user terminal is defined based on the received satellite beam signal and the calculated on-earth footprint thereof. The position of the user terminal is defined inside the coverage area, the on-earth footprint, of the received satellite beam signal.

In some embodiments, the method comprises receiving two or more satellite beam signals from one or more satellites in a user terminal, each of the received two or more satellite beam signals comprising a unique beam identifier. The method further comprises identifying the one or more satellites from which the two or more satellite beam signals are received based on the unique beam identifiers, and acquiring satellite-to-earth-geometry data of the identified one or more satellites, the satellite-to-earth-geometry data comprising satellite location information in time-domain. The method further comprises calculating on-earth footprints of the received two or more satellite beam signals based on the satellite-to-earth-geometry data of the identified one or more satellites, the on-earth footprints comprising location information of the on-earth footprints, and calculating position of the user terminal based on the on-earth footprints of the received two or more satellite beam signals, the position of the user terminal being defined in an overlapped footprint area of the calculated on-earth footprints of the received two or more satellite beam signals.

In the context of this application the positioning the user terminal may be carried out based on one received satellite beam signal. However, when the positioning is carried out based two or more simultaneously received satellite beam signals the accuracy is increased.

The information concerning satellites is available in satellite databases as the satellite-to-earth-geometry data. These databases and the satellite-to-earth-geometry data comprise satellite specific satellite location information in time-domain, meaning timestamped location in orbit or ephemeris, as well as satellite technical data.

The satellite beam signals transmitted from the satellites comprise unique identifiers identifying the specific satellites and the specific satellite beam signal transmitted form the satellite to the Earth.

The geographical coverage area of the specific satellite beam signal in a given timepoint or in time-domain can be calculated based on the satellite-to-earth-geometry data. Each satellite beam signal has a coverage area on Earth and the coverage area is configured to define an on-earth footprint on the surface of the Earth.

When the user terminal is able to receive a satellite beam signal from a satellite, it means the user terminal is positioned in the footprint, or coverage area, the received satellite beam signal and the corresponding satellite. Then calculating the location, or coordinates, of the footprint based on the satellite-to-earth-geometry data of the identified satellite and satellite beam signal provides position of the user terminal.

As the user terminal receives two or more satellite beam signal simultaneously, it means the user terminal is within footprints of two or more satellite beam signals simultaneously. This means, that the user terminal is positioned to overlapped footprint area in which all the footprints of the received two or more satellite beam signals overlap. Accordingly, the position of the user terminal is defined to be in the overlapped footprint area.

In the present invention the user terminal receives and is configured to receive simultaneously two or more satellite beam signal.

For receiving simultaneously two or more satellite beam signal, the user terminal is provided with a multiple-input antenna.

Based on the present invention, the positioning of the user terminal is carried out only based on the unique identifiers of the satellite beam signals. Therefore, no high-precision calculations and time-delay measurements are not needed.

The on-earth footprint area is configured to define geographical coordinates of the coverage area of the satellite beam signal on Earth.

The on-earth footprint area comprises geographical coordinates of the coverage area of the satellite beam signal on Earth.

In some embodiments, at least one of the two or more satellite beam signals is received from a satellite configured to transmit single satellite beam signal, and that the two or more satellite beam signals are received from at least two separate satellites.

Some satellites are configured to transmit only one satellite beam signal and in this case the positioning of the user terminal is carried out based on receiving satellite beam signals from at least two separate satellites for calculating the overlapped footprint area.

In some embodiments, at least one of the two or more satellite beam signals are received from a satellite configured to transmit multiple satellite beam signals in a beam pattern.

Some satellites are configured to transmit two or more satellite beam signals and in this case the positioning of the user terminal is carried out based on receiving satellite beam signals from at least one satellite for calculating the overlapped footprint area.

In some embodiments, the two or more satellite beam signals are received from a single satellite configured to transmit multiple satellite beam signals in the beam pattern, the beam pattern of the satellite comprising two or more two or more satellite beam signals having at least partly overlapped on-earth footprints.

The positioning based on satellite beam signals from only one satellite requires that signal pattern of the two or more satellite beam signals of the one satellite comprises at least partly overlapping satellite beam signals. This enables positioning also when only one satellite is available.

In some other embodiments, the two or more satellite beam signals are received at least two separate satellites.

In this case each or two or more satellites are configured transmit two or more satellite beam signals. In this case the positioning accuracy is enhanced. In some embodiments, the two or more satellite beam signals are received from one or more Low Earth Orbit (LEO) satellites.

There is great and increasing number of LEO satellites available enabling increased positioning accuracy. Further, received signal strength of satellite beam signals from LEO satellites is high.

In some embodiments, acquiring the satellite-to-earth-geometry data of the identified one or more satellites comprises acquiring the satellite-to-earth-geometry data from the identified satellite based on the unique beam identifiers of the received the two or more satellite beam signals.

In this embodiment at least part of the satellite-to-earth-geometry data is included or embedded to the satellite beam signals. Thus, at least part of the satellite-to-earth-geometry data is received in the user terminal in the received the satellite beam signals.

In some other embodiments, acquiring the satellite-to-earth-geometry data of the identified one or more satellites comprises acquiring the satellite-to-earth-geometry data from an external satellite database of an external server based on the unique beam identifiers of the received the two or more satellite beam signals.

In this embodiment, at least part of the satellite-to-earth-geometry data is stored in the external satellite database in the external server. The unique identifiers of the received satellite beam signals are utilized as tokens or the like to acquire satellite-to-earth-geometry data of the identified satellites and the signals thereof from the external satellite database.

In some further embodiments, acquiring the satellite-to-earth-geometry data of the identified one or more satellites comprises acquiring the satellite-to-earth-geometry data from an internal satellite database of the user terminal based on the unique beam identifiers of the received the two or more satellite beam signals.

In this embodiment, at least part of the satellite-to-earth-geometry data is stored in the internal satellite database in the user terminal. The unique identifiers of the received satellite beam signals are utilized as tokens or the like to acquire satellite-to-earth-geometry data of the identified satellites and the signals thereof from the internal satellite database.

It should be noted that in some embodiments, the satellite-to-earth-geometry data may be provided as distributed data. Therefore, the satellite-to-earth-geometry data may be acquired in any combination of the above:
partly from the satellite and partly from the external database; or
partly from the satellite and partly form the internal database; or
partly from the external database and partly from the internal database; or
partly form the satellite, partly from the external database and partly from the internal database.

In some embodiments, the satellite-to-earth-geometry data comprises dynamic data comprising satellite ephemeris data, or satellite ephemeris data and satellite orientation data, and calculating the on-earth footprints of the received two or more satellite beam signals is carried out by utilizing the dynamic data of satellite-to-earth-geometry data.

The dynamic data comprises location data of the satellite in time-domain. The location data means timestamped location in orbit. The dynamic data may also comprise satellite orientation data in time-domain. The orientation data comprises direction of the satellite beam signals in relation to the Earth.

In some embodiments, the satellite-to-earth-geometry data comprises static data comprising satellite antenna attributes data and the beam pattern data, and calculating the on-earth footprints of the received two or more satellite beam signals is carried out by utilizing the dynamic data and the static data of satellite-to-earth-geometry data.

The static data comprises static satellite attributes such as the antenna attributes, beam pattern in satellites transmitting multiple satellite signal beams, beam identifiers and signal strengths of the satellite beam signals.

In some embodiments, calculating position of the user terminal based on the on-earth footprints of the received two or more satellite beam signals comprises calculating the overlapped footprint area of the calculated on-earth footprints of the received two or more satellite beam signals.

Calculating the overlapped footprint area defines the area in which the user terminal is positioned. The overlapped area is smaller than an individual on-earth footprint provided increased positioning accuracy.

In some embodiments, the method further comprises estimating position of the user terminal inside the overlapped footprint area based on the satellite beam signals of the identified satellites.

Accordingly, the information of the satellite beam signals transmitted by the satellite(s) is used for providing further positioning accuracy.

In some embodiments, the method further comprises estimating position of the user terminal inside the overlapped footprint area based on the beam pattern data.

The overall beam patterns of the satellites from which the satellite beam signals are received is utilized for calculating the position of the user terminal inside the overlapped footprint area.

In some other embodiments, the method further comprises estimating position of the user terminal inside the overlapped footprint area based on the antenna attributes data.

The antenna attributes are configured to define the satellite beam signal attributes, such as signal strength or the like, which are utilized for calculating a focused position of the user terminal inside the overlapped footprint area.

In some further embodiments, the method further comprises estimating position of the user terminal inside the overlapped footprint area based on the antenna attributes data and the beam pattern data.

Accordingly, calculating the position of the user terminal inside the overlapped footprint area is carried out by utilizing both the antenna attributes data and the beam pattern data.

In some embodiments, the method comprises calculating on-earth footprints of all satellite beam signals of the identified one or more satellites based on the satellite-to-earth-geometry data, calculating the overlapped footprint area of the calculated on-earth footprints of the received two or more satellite beam signals, and calculating a focused overlapped footprint area by subtracting from the overlapped footprint area the on-earth footprints of the identified one or more satellites which corresponds one or more non-received satellite beam signals.

As each satellite can transmit many beams and each beam has the beam identifier. The unique beam identifier comprises identifier for the satellite as well as for the specific beam. The coverage area, on-earth footprint, of each beam may be calculated based on the satellite-to-earth-geometry data in time-domain at every timepoint. Once the user terminal receives at least one of the satellite beam signals of the satellite, satellite-to-earth-geometry data of all satellite signal beams of this satellite can be retrieve from the satellite database. Accordingly, the satellite-to-earth-geometry data of the non-received satellite beam signals of the satellite is also retrieved. The method and system then utilizes the satellite-to-earth-geometry data all the received satellite beam signal as well as the non-received satellite beam signals to improve the accuracy of the positioning.

Accordingly, the satellites from which satellite beam signals are received are identified and the on-earth footprints of all satellite beam signals from the identified satellites are calculated. The user terminal is defined to have position inside the overlapped footprint area. When there are satellites transmitting multiple satellite beam signals, it is determined also the on-earth footprints which correspond to satellite beam signals not received by the user terminal. When there are numerous satellite bema signals, there exists on-earth footprints which correspond to satellite beam signals not received by the user terminal and which overlap with the calculated overlapped footprint area. Subtracting the on-earth footprints which correspond to satellite beam signals and overlap with the calculated overlapped footprint area decreases the area in which the user terminal is positioned and provide a focused overlapped footprint area.

In some other embodiments, the method comprises calculating the overlapped footprint area of the calculated on-earth footprints of the received two or more satellite beam signals, calculating on or more adjacent on-earth footprints of one or more adjacent non-received satellite beam signals of the identified one or more satellites based on the satellite-to-earth-geometry data, the one or more adjacent non-received satellite beam signals are configured to generate the one or more adjacent on-earth footprints which overlap at least partly with the one or more on-earth footprints configured to form the overlapped footprint area, calculating a focused overlapped footprint area by subtracting the one or more adjacent on-earth footprints of the identified one or more satellites which corresponds one or more non-received satellite beam signals.

In this embodiment only the on-earth footprints of satellite beam signals which are adjacent to the received satellited beam signals in the beam pattern are subtracted from the overlapped footprint area. This decreases calculation volume and provides enhanced positioning accuracy at the same time.

In some embodiments, the method comprises acquiring maximum signal strengths of the one or more received satellite beam signals from the static data of satellite-to-earth-geometry data, calculating a centre point location of the one or more on-earth footprints of the one or more received satellite beam signals, the maximum signal strength of each received satellite beam signal being at the centre point of the corresponding on-earth footprint, determining signal strengths of the one or more received satellite beam signals, and calculating position of the user terminal inside the overlapped footprint area of the focused overlapped footprint area based on the maximum signal strengths and the determined signal strengths of the one or more received satellite beam signals.

The signal strength is highest at the centre of the footprint area. Therefore, the position of the user terminal in relation to the centre point of each of the on-earth footprints of the received satellite beam signals is configured to be calculated. This calculation is further combined with the calculation of the overlapped footprint area. Thus, the combined calculation provides enhanced positioning accuracy of the user terminal inside the overlapped footprint area. Accordingly, the position of the user terminal inside the overlapped footprint area is calculated based on the signal strengths and the overlapped footprint area.

Alternatively, a focused overlapped footprint area of the user terminal inside the overlapped footprint area is calculated based on the signal strengths and the overlapped footprint area. This the focused overlapped footprint area inside the overlapped footprint area is calculated based on the on the signal strengths and the overlapped footprint area.

The method further comprises generating or calculating position information based on the calculated overlapped footprint area or the focused overlapped footprint area. The position information comprises geographical coordinates of the overlapped footprint area or the focused overlapped footprint area and thus geographical position of the user terminal.

The method further comprises generating a visual representation of the position information.

In some embodiment, the method comprises providing electronic map information. The electronic map information comprises visual representation of a map and geographical coordinates associated with the visual representation of the map. The method further comprises generating a visual representation of the position information. The method further comprises associating the visual representation of the position information based on the geographical coordinates. The method also comprises displaying the visual representation of the position information on the electric map information on a display of the user terminal and/or an external device.

The present invention is further based on an idea of providing a system for positioning. The system comprises a user terminal configured to receive one or more satellite beam signals from one or more satellites, each of the received one or more satellite beam signals comprising a unique beam identifier.

The system further comprises a positioning module configured to identify the one or more satellites from which the one or more satellite beam signals are received based on the unique beam identifiers, acquire satellite-to-earth-geometry data of the identified one or more satellites from a satellite database, the satellite-to-earth-geometry data comprising satellite location and direction information in time-domain, calculate on-earth footprints of the received one or more satellite beam signals based on the satellite-to-earth-geometry data of the identified one or more satellites, the on-earth footprints comprising location information of the on-earth footprints, and calculate position of the user terminal based on the on-earth footprints of the received two one or more satellite beam signals, the position of the user terminal being defined in the calculated on-earth footprints of the received two one or more satellite beam signals.

In some preferred embodiments, the user terminal configured to receive two or more satellite beam signals simultaneously from one or more satellites, each of the received two or more satellite beam signals comprising a unique beam identifier. The system further comprises the positioning module configured to
identify the one or more satellites from which the two or more satellite beam signals are received based on the unique beam identifiers,
acquire satellite-to-earth-geometry data of the identified one or more satellites from a satellite database, the satellite-to-earth-geometry data comprising satellite location and direction information in time-domain,
calculate on-earth footprints of the received two or more satellite beam signals based on the satellite-to-earth-geometry data of the identified one or more satellites, the on-earth footprints comprising location information of the on-earth footprints, and
calculate position of the user terminal based on the on-earth footprints of the received two or more satellite beam signals, the position of the user terminal being defined in an overlapped footprint area of the calculated on-earth footprints of the received two or more satellite beam signals.

The system of the present invention enables positioning of the user terminal is carried out only based on the unique identifiers of the satellite beam signals. Therefore, no high-precision calculations and time-delay measurements are not needed.

In some embodiments, the user terminal is a mobile user device or a wearable user device.

The user terminal may be any kind of user terminal comprising a satellite signal receiver. The user terminal may be a mobile phone, smart watch, laptop, tablet computer, cycling computer, a communication unit of a car or a train or the like device comprising a receiver configured to receive satellite beam signals. The user terminal comprises a receiver configured to receive simultaneous multiple satellite beam signals.

In some embodiments, the user terminal comprises a multiple-input antenna or a multiple-input receiver configured to receive multiple satellite beam signals simultaneously.

In some embodiments, at least one of the one or more satellites comprises a single-output antenna configured to transmit single satellite beam signal.

In some embodiments, at least one of the one or more satellites comprises a multiple-output antenna or a multiple-output transmitter configured to transmit multiple satellite beam signals in a beam pattern.

Simultaneous receiving of satellite beam signals enables providing the overlapped footprint area.

In some embodiments, the two or more satellite beam signals are received from one or more Low Earth Orbit satellites.

Accordingly, in some embodiments the system comprises LEO satellites.

LEO satellites are satellites having geocentric orbits with altitudes below 2000 km.

In some embodiments, the system is configured to carry out the method according to above disclosed.

An advantage of the invention is that the positioning method and system of the present invention is not dependent on accurate received signal strength values, time corrections, or other measurements. Therefore, the method and system of the present invention is able to provide world-wide robust and low-cost positioning services. Further, when utilizing LEO satellites several benefits may be achieved. The LEO satellite signals have higher received signal strength than GNSS signals enabling better positioning also in places with signal interfering objects. Further, the number of LEO satellites is continuously increasing which enables positioning accuracy and reliability to be increased.

### BRIEF DESCRIPTION OF THE DRAWINGS

The invention is described in detail by means of specific embodiments with reference to the enclosed drawings, in which

FIGS. 1 and 2 show schematically one embodiment of the present invention;

FIGS. 3 and 4 show schematically another embodiment of the present invention;

FIG. 5 shows schematically a further embodiment of the present invention;

FIG. 6 shows schematically positioning of a user terminal based on the received satellite beam signals;

FIG. 7 shows schematically one embodiment of the system according to the present invention;

FIG. 8 shows schematically another embodiment of the system according to the present invention;

FIG. 9 shows schematically software component of the positioning system;

FIG. 10 shows schematically one embodiment of an enhanced positioning of a user terminal based on the satellite beam signals; and

FIG. 11 shows schematically another embodiment of an enhanced positioning of a user terminal based on the satellite beam signals.

### DETAILED DESCRIPTION OF THE INVENTION

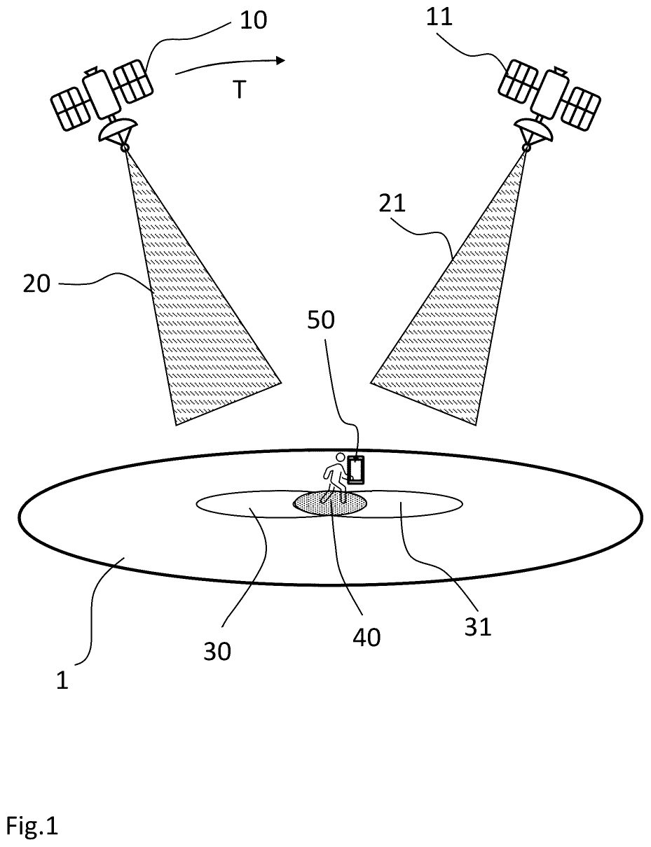

FIG. 1 shows schematically the system and method present invention. The present invention is based on an idea of determining position of a user terminal 50 based on satellite beam signals 20, 21 transmitted from one or more satellites 10, 11 and received in the user terminal 50.

The satellites 10 ,11 or satellite constellations are divided to different categories based on their orbit altitude from the sea level. The prior art GNSS satellites have orbits at altitudes from 2000 to 35000 km. This mentioned altitude range between 2000 to 35000 km is called Medium Earth orbit (MEO) and the satellites are called MEO satellites.

Low Earth orbit (LEO) satellites, LE satellites, have orbits at altitudes less than 2000. LEO satellites are used mainly for communication applications.

The present invention is not restricted to any specific type of satellites 10, 11. However, LEO satellites are preferable as they require the lowest amount of energy for satellite placement on orbits, and thus the number of LEO satellites is expected to increase.

Each satellite beam signals 20, 21 provides a coverage area 30, 31 on Earth. The coverage area provides an on-earth footprint 30, 31 on Earth surface 1. The satellite beam signals 20, 21 of the corresponding satellites 10, 11, can be received by the user terminal inside the on-earth footprint 30, 31. Thus, the satellite beam signals 20, 21 of the corresponding satellites cannot be received by the user terminal 50 outside the on-earth footprint 30, 31, as there is not coverage outside the on-earth footprints 30, 31 of the corresponding satellites 10, 11.

LEO satellites are configured to generate small coverage areas 30, 31 as they are at low altitudes.

Each satellite beam signal 20, 21 transmitted from the satellites has a unique beam identifier. The unique beam identifiers are provided to the satellite beam signal 20, 21. The unique beam identifier is configured identify and distinguish the satellite beam signal 20, 21 from other satellite beam signals 20, 21.

The unique beam identifier is associated to a specific satellite signal beam 20, 21 and to a specific satellite 10, 11. Accordingly, the unique beam identifier is configured to identify the specific satellite 10, 11 and a specific satellite beam signal of the specific satellite 10, 11.

Each satellite 10, 11 is configured to travel on a predetermined orbit around the Earth. Accordingly, location of each satellite 10, 11 on the orbit in-time domain is known. This timestamped location of a satellite 10, 11 on the orbit is called ephemeris data. The ephemeris data is stored as satellite-to-earth-geometry data. The ephemeris of the satellite 10, 11 may be determined at any given timepoint based on the ephemeris and the satellite-to-earth-geometry data.

Accordingly, the satellite-to-earth-geometry data is configured to determine the location of the satellite 10, 11 in relation to Earth in time-domain.

The satellite-to-earth-geometry data may in some embodiments also comprise satellite orientation data. The satellite orientation data defines the orientation of the satellite 10, 11 on the orbit. The orientation of the satellite 10, 11 further defines the transmission direction of satellite beam signals 20, 21 towards the earth. The satellite orientation data is configured to define timestamped orientation of the satellite 10, 11 on the orbit.

The satellite orientation data is stored to satellite-to-earth-geometry data. Accordingly, the satellite orientation data and the satellite-to-earth-geometry data are configured to determine the orientation of the satellite 10, 11 in time-domain and at any given timepoint.

The ephemeris data, or the ephemeris data and the satellite orientation data are provided as dynamic data. Accordingly, the ephemeris of the satellite and the orientation of the satellite changes in time-domain.

In some embodiments, the satellite-to-earth-geometry data comprises also static data. The static data refers to data which remains static in time-domain.

The static data comprises at least antenna attributes, beam pattern data and the beam identifiers.

The antenna attributes comprise technical antenna characteristic and signal strength data.

The beam pattern data defines pattern of the one or more satellite beam signals 20, 21 transmitted from the satellite 10, 11.

In some embodiments, the satellite-to-earth-geometry data of the satellite 10, 11 is provided to the satellite beam signal 20, 21 and is thus received together with the satellite beam signal 20, 21.

In some embodiments, the satellite-to-earth-geometry data is stored to a satellite database in the satellite. The user terminal is configured to retrieve the satellite-to-earth-geometry data from the satellite database in the satellite 10, 11 in response to receiving the satellite beam signal 20, 21.

In some embodiments, the satellite-to-earth-geometry data of the satellite 10, 11 is stored to the satellite database stored in the user terminal 50. The user terminal 50 is configured to acquire the satellite-to-earth-geometry data from the satellite database in the user terminal 50 in response to receiving the satellite beam signal 20, 21.

In some embodiments, the satellite-to-earth-geometry data of the satellite 10, 11 is stored to the satellite database stored in an external server. The user terminal is configured to acquire or the satellite-to-earth-geometry data from the satellite database in the user terminal 50 in response to receiving the satellite beam signal 20, 21. Alternatively, the external server is configured to acquire or the satellite-to-earth-geometry data from the satellite database in the user terminal 50 in response to receiving the satellite beam signal 20, 21.

In some embodiments of the invention the satellite database is provided as a distributed database. In the distributed satellite database, the satellite-to-earth-geometry data is distributed between at least two of the following: the satellites, the user terminal 50 and the external server. The satellite-to-earth-geometry data may be distributed in any manner between the satellites, the user terminal 50 and the external server.

The user terminal 50 is configured process or decode received satellite beam signals 20, 21 to identify the unique beam identifiers of the received satellite beam signals 20, 21.

The satellite-to-earth-geometry data comprises the unique beam identifiers or the unique beam identifiers are store to the satellite-to-earth-geometry data.

When the user terminal 50 has received the satellite beam signals 20, 21 and the unique beam identifiers of the received satellite beam signals 20, 21 are identified, the method and system in configured to identify the satellites 10, 11 from which the received satellite beam signals 20, 21 are transmitted based on the unique beam identifiers.

Identification of the satellites 10, 11 from which the received satellite beam signals 20, 21 are transmitted is carried out by compering the unique beam identifiers of the received satellite beam signals 20, 21 to unique beam identifiers stored to the satellite database in connection with satellite-to-earth-geometry data of each satellite 10, 11.

The method and system are configured to acquire the satellite-to-earth-geometry data of the satellites 10, 11 from which the satellite beam signals 20, 21 are received. The satellite-to-earth-geometry data of the satellites 10, 11 from which the satellite beam signals 20, 21 is acquired based on the identified satellites 10, 11 and/or based on the unique beam identifiers of the received satellite beam signals 20, 21.

Accordingly, the unique beam identifiers of the received satellite beam signals 20, 21 are utilized as tokens for acquiring or retrieving the satellite-to-earth-geometry data of corresponding satellites 10, 11.

One or more of the satellites 10, 11 may be configured to transmit single satellite beam signal 20, 21. Thus, the satellite 10, 11 may comprise a single-output antenna or the antenna is configured to provide single signal output.

Alternatively, one or more of the satellites 10, 11 may be configured to transmit multiple satellite beam signals 20, 21 in a predetermined beam pattern. Thus, the satellite 10, 11 may comprise a multiple-output antenna or the antenna is configured to provide multiple signal output.

The beam pattern data defines the pattern of the multiple satellite beam signal 20, 21 transmitted from them satellite 10, 11.

In some embodiments, the antenna is a multiple-input multiple-output (MIMO) antenna.

LEO satellites with multiple-output, or with MIMO antennas, are configured generate two or more satellite beam signals 20, 21 and further form two or more small on-earth footprints. Thus, a more detailed satellite beam signal resolution is generated.

FIG. 1 shows schematically one embodiment of the present invention. The satellites 10, 11 travel on both on their own orbit T. Both satellites 10, 11 are configured to transmit one satellite signal 20, 21 respectively.

Each of the satellite signals 20, 21 form a coverage area, meaning the on-earth footprint 30, 31, on Earth surface 1. The satellite signals 20, 21 can be received by a user terminal 50 within or inside the on-earth footprints 30, 31 of the respective satellite beam signals 20, 21.

Accordingly, when the user terminal 50 receives a certain satellite beam signal 20, 21 it is within the coverage area, or the on-earth footprint 30, 31, of the certain satellite beam signal 20, 21. Further, when the user terminal 50 receives two or more certain satellite beam signals 20, 21 it is within the coverage area, or the on-earth footprint 30, 31, of all of the two or more certain satellite beam signals 20, 21. Therefore, the user terminal 50 is in an area in which the on-earth footprints 30, 31 of all the received two or more certain satellite beam signals 20, 21 are overlapped. Accordingly, in the user terminal 50 is positioned within an overlapped footprint area 40 of the received two or more satellite beam signals 20, 21, as shown in FIG. 1.

In order to determine geographical position of the user terminal 50, the on-earth footprints 30, 31 of the received satellite beam signals 20, 21 needs to be calculated at timepoint the satellite beam signals 20, 21 are received. Accordingly, the geographical location of the on-earth footprints 30, 31 needs to be calculated.

When the geographical location of each of the on-earth footprints 30, 31 of the received satellite beam signals 20, 21 is calculated, the overlapped footprint area 40 is calculated based on the on-earth footprints 30, 31 of the received satellite beam signals 20, 21.

The geographical position of the user terminal 50 is within the overlapped footprint area 40.

In the present invention the user terminal 50 receives or is configured to receive two or more satellite beam signals 20, 21 simultaneously from one or more satellites 10.

The satellite-to-earth-geometry data of the identified one or more satellites 10, 11 is acquired based on the unique beam identifiers of the received satellite beam signals 20, 21.

The on-earth footprints 30, 31 of the received satellite beam signals 2021 are calculated based on the satellite-to-earth-geometry data.

The on-earth footprints 30, 31 are calculated by utilizing the dynamic data, or dynamic data and static data of the satellite-to-earth-geometry data.

In some embodiments, the system and method of the present invention comprises footprint calculation model. The satellite-to-earth-geometry data is provided as input data to the footprint calculation model. The output data of the footprint calculation model is the on-earth footprints 30, 31 of the received satellite beam signals 20, 21.

The on-earth footprints 30, 31 is configured to the area of the on-earth footprints 30, 31 as well as geographical location of the on-earth-footprints 30, 31. The footprint calculation model may comprise the ephemeris data, the orientation data, antenna attributes and beam pattern data of the satellite 10, 11 for calculating the on-earth footprints 30, 31.

The satellite-to-earth-geometry data or the ephemeris data may also comprise data of one or more of the following: elevation angle, satellite orbital inclination angle, satellite altitude, and the attributes of the beam shape.

In some embodiments, the beam shape is provided in the footprint calculation model as beam shape model, such as symmetrical conical beam shape.

In some embodiments, the antenna attributes of the satellites 10, 11 are configured to determine beam forming parameters and the beam shape.

The on-earth footprints 30, 31 of the received satellite beam signals 20, 21 comprise geographical location data of the on-earth footprints 30, 31. The geographical location data comprises geographical coordinates defining location and area of the on-earth footprints 30, 31. The geographical location data and the geographical coordinates define the perimeter or borders of the on-earth footprints 30, 31. The coverage area being inside the perimeter or borders of the on-earth footprints 30, 31.

When the on-earth footprints 30, 31 of the received satellite beam signals 20, 21 are calculated, the position of the user terminal 50 is calculated based on the on-earth footprints 30, 31 of the received satellite beam signals 20, 21.

The position of the user terminal 50 is calculated based on the on-earth footprints 30, 31 of the received satellite beam signals 20, 21.

The position of the user terminal 50 is calculated by calculating the overlapped footprint area 40 of the on-earth footprints 30, 31 of the received satellite beam signals 20, 21. The user terminal 40 is positioned in the overlapped footprint area 40.

In some embodiments, the system and method of the present invention comprises a position calculation model. The on-earth footprints 30, 31 of the received satellite beam signals 20, 21 are provided as input data to the position calculation model. The output data of the position calculation model is the overlapped footprint area 40.

Calculating the on-earth footprints 30, 31 of the received satellite beam signals 20, 21 comprises calculating the perimeters of the on-earth footprints 30, 31. The perimeters are calculated by utilizing the antenna attributes and the beam pattern data. The beam pattern data comprises beam geometry data defining the geometry of the beam along the path from the satellite 10, 11 towards the Earth.

In some embodiments, the beam geometry data comprises a predetermined beam geometry design. The predetermined beam geometry design is provided to the footprint calculation model for calculating the on-earth footprints 30, 31.

FIG. 1 shows one embodiment of the present invention in which the user terminal 50 receives a first satellite beam signal 20 from a first satellite 10 and a second satellite beam signal 21 from a first satellite 11.

In the embodiments of FIG. 1, the first and second satellites 10, 11 are configured to transmit only one satellite beam signal 20, 21.

The method and system comprise calculating the on-earth footprints 30, 31 of the received first and second satellite beam signals 20, 21.

The method and system further comprise calculating the overlapped footprint area 40 based on the calculated on-earth footprints 30, 31 of the received first and second satellite beam signals 20, 21.

In FIG. 1, the user terminal 50 receives satellite beam signals 20, 21 from two satellites 10, 11. However, the user terminal 50 may receive satellite beam signals 20, 21 also from more than two satellites 10, 11.

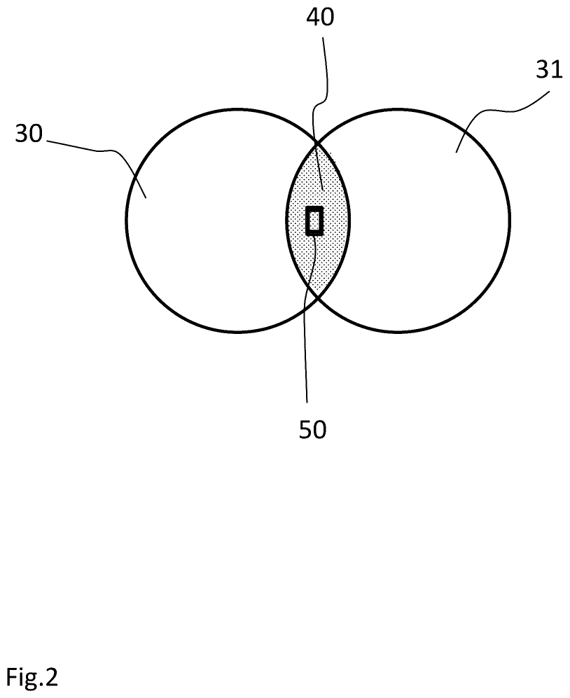

FIG. 2 shows schematically the calculated on-earth footprints 30, 31 of the received first and second satellite beam signals 20, 21 of FIG. 1 and the calculated overlapped footprint area 40 inside which the user terminal is positioned.

Accordingly, the position of user terminal 50 is determined based on the simultaneously received satellite beam signals 20, 21 from at least two

### Different Satellites 10, 11.

The overlapped footprint area 40 becomes smaller as the number of satellites 10, 11 increase and as the number of simultaneously received satellite beam signal 20, 21 increase. Thus, the positioning accuracy also increases.

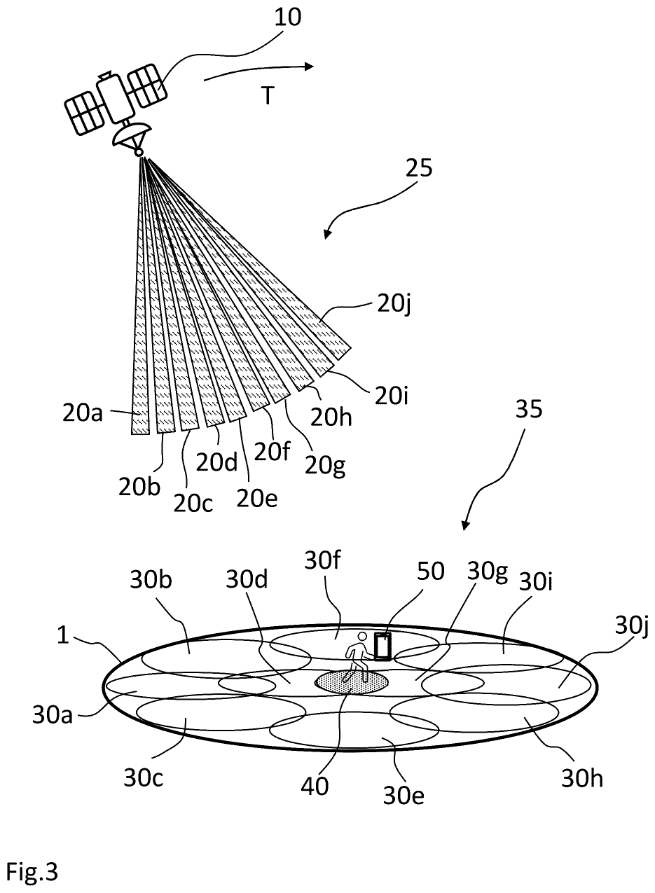

FIG. 3 shows another embodiment in which the satellite 10 is configured to transmit multiple satellite beam signals 20a, 20b, 20c, 20d, 20e, 20f, 20g, 20h, 20i, 20j in a predetermined beam pattern 25.

The satellite 10 comprises a multiple-output antenna or a MIMO antenna configured to transmit simultaneously the multiple satellite beam signals 20a, 20b, 20c, 20d, 20e, 20f, 20g, 20h, 20i, 20j in the predetermined beam pattern 25.

In the satellite beam signals 20a, 20b, 20c, 20d, 20e, 20f, 20g, 20h, 20i, 20j in the predetermined beam pattern 25 are partly overlapped with each other. Accordingly, each satellite beam signal 20a, 20b, 20c, 20d, 20e, 20f, 20g, 20h, 20i, 20j in the predetermined beam pattern 25 is overlapped partly with at least one adjacent satellite beam signals 20a, 20b, 20c, 20d, 20e, 20f, 20g, 20h, 20i, 20j.

Each satellite beam signals 20a, 20b, 20c, 20d, 20e, 20f, 20g, 20h, 20i, 20j in the predetermined beam pattern 25 provides a corresponding on-earth footprint 30a, 30b, 30c, 30d, 30e, 30f, 30g, 30h, 30i, 30j on Erath surface 1. The on-earth footprints 30a, 30b, 30c, 30d, 30e, 30f, 30g, 30h, 30i, 30j are partly overlapped as a response to partly overlapped satellite beam signals 20a, 20b, 20c, 20d, 20e, 20f, 20g, 20h, 20i, 20j.

Accordingly, the multiple satellite beam signals 20a, 20b, 20c, 20d, 20e, 20f, 20g, 20h, 20i, 20j of the beam pattern 25 are configured to provide a footprint pattern 35 comprising partly overlapped on-earth footprints 30a, 30b, 30c, 30d, 30e, 30f, 30g, 30h, 30i, 30j, as shown in FIG. 3.

In the embodiment of FIG. 3, the user terminal 50 receives a satellite beam signal 20d the satellite 10 and a satellite beam signal 20g from the satellite 10. Accordingly, the user terminal 50 receives two separate satellite beam signals 20d, 20g from the same satellite 10.

In the embodiments of FIG. 3, the satellites 10 are configured to transmit the multiple satellite beam signals 20a, 20b, 20c, 20d, 20e, 20f, 20g, 20h, 20i, 20j.

The method and system comprise calculating the on-earth footprints 30d, 30g of the received satellite beam signals 20d, 20g.

The method and system further comprise calculating the overlapped footprint area 40 based on the calculated on-earth footprints 30d, 30g of the received satellite beam signals 20d, 20g.

In FIG. 3, the user terminal 50 receives two satellite beam signals 20d, 20g from one satellite 10. However, the user terminal 50 may also receive more than two satellite beam signals 20a, 20b, 20c, 20d, 20e, 20f, 20g, 20h, 20i, 20j from one satellited.

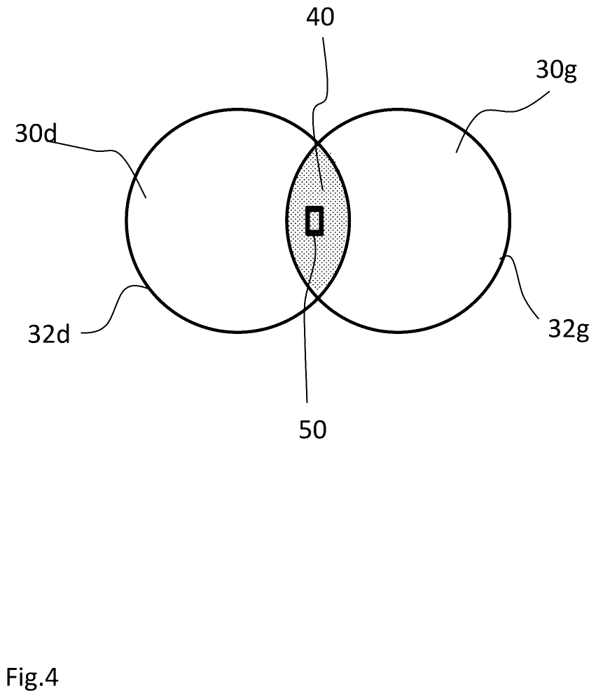

FIG. 4 shows schematically the calculated on-earth footprints 30d, 30g of the received satellite beam signals 20d, 20g of FIG. 3 and the calculated overlapped footprint area 40 inside which the user terminal 50 is positioned.

Accordingly, the position of user terminal 50 is determined based on the simultaneously received satellite beam signals 20d, 20g.

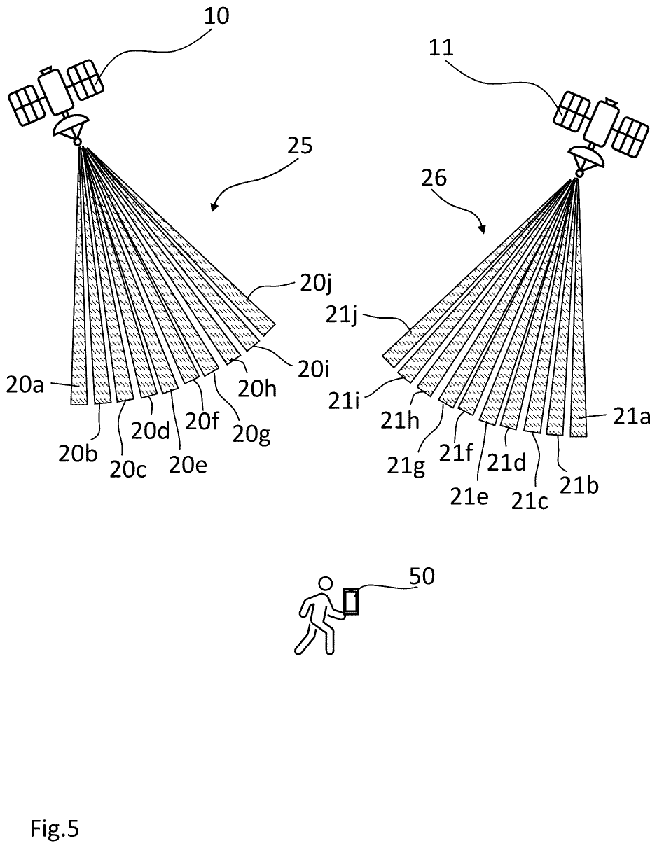

FIG. 5 shows yet another embodiment in which a first satellite 10 is configured to transmit multiple first satellite beam signals 20a, 20b, 20c, 20d, 20e, 20f, 20g, 20h, 20i, 20j in a first predetermined beam pattern 25 and a second satellite 11 is configured to transmit multiple second satellite beam signals 21a, 21b, 21c, 21d, 21e, 21f, 21g, 21h, 21i, 21j in a second predetermined beam pattern 26.

The first and second satellites 10, 11 comprises multiple-output antennas or a MIMO antennas configured to transmit simultaneously the multiple first satellite beam signals 20a, 20b, 20c, 20d, 20e, 20f, 20g, 20h, 20i, 20j in the first predetermined beam pattern 25 and the multiple second satellite beam signals 21a, 21b, 21c, 21d, 21e, 21f, 21g, 21h, 21i, 21j in the second predetermined beam pattern 26, respectively.

Each first satellite beam signals 20a, 20b, 20c, 20d, 20e, 20f, 20g, 20h, 20i, 20j in the first predetermined beam pattern 25 provides a corresponding first on-earth footprints on Erath surface 1.

Each second satellite beam signals 21a, 21b, 21c, 21d, 21e, 21f, 21g, 21h, 21i, 21j in the second predetermined beam pattern 26 provides a corresponding second on-earth footprints on Erath surface 1.

The multiple first satellite beam signals 20a, 20b, 20c, 20d, 20e, 20f, 20g, 20h, 20i, 20j of the first beam pattern 25 may be configured to provide the first footprint pattern comprising partly overlapped first on-earth footprints 30a, 30b, 30c, 30d, 30e, 30f, 30g, 30h, 30i, 30j, as shown in FIG. 3.

Further, the multiple second satellite beam signals 21a, 21b, 21c, 21d, 21e, 21f, 21g, 21h, 21i, 21j of the second beam pattern 26 may be configured to provide the second footprint pattern comprising partly overlapped second on-Earth footprints.

It should be noted the first and/or second beam patterns 25, 26 and the respective first and second footprint patterns may also be non-overlapped.

Further, it should be noted that in the context of the present invention there may be one or more separate satellites 10, 11 from which the user terminal 50 receives satellite beam signals. One or more of the satellites 10, 11 may be configured to transmit multiple satellite beam signals simultaneously. Further, one or more of the satellites 10, 11 may be configured to transmit a single satellite beam signal. Alternatively, all the satellites 10, 11 may be configured to transmit multiple satellite beam signals simultaneously. Further alternatively, all the satellites 10, 11 may be configured to transmit a single satellite beam signal.

In the embodiment of FIG. 5, the user terminal 50 may receive one or mor first satellite beam signals 20a, 20b, 20c, 20d, 20e, 20f, 20g, 20h, 20i, 20j and one or more second satellite beam signals 21a, 21b, 21c, 21d, 21e, 21f, 21g, 21h, 21i, 21j. The user terminal 50 may also receive one or more further satellite beam signals from further satellites.

Accordingly, the method and system of the present invention is not restricted to any number of satellites 10, 11. The user terminal 50 may receive two or more satellite beam signals from any number satellites simultaneously.

According to the method and system of the present invention, on-earth footprints 30, 31 of the received satellite beam signals 20, 21 are calculated. The overlapped footprint area 40 is further calculated based on the calculated on-earth footprints 30, 31.

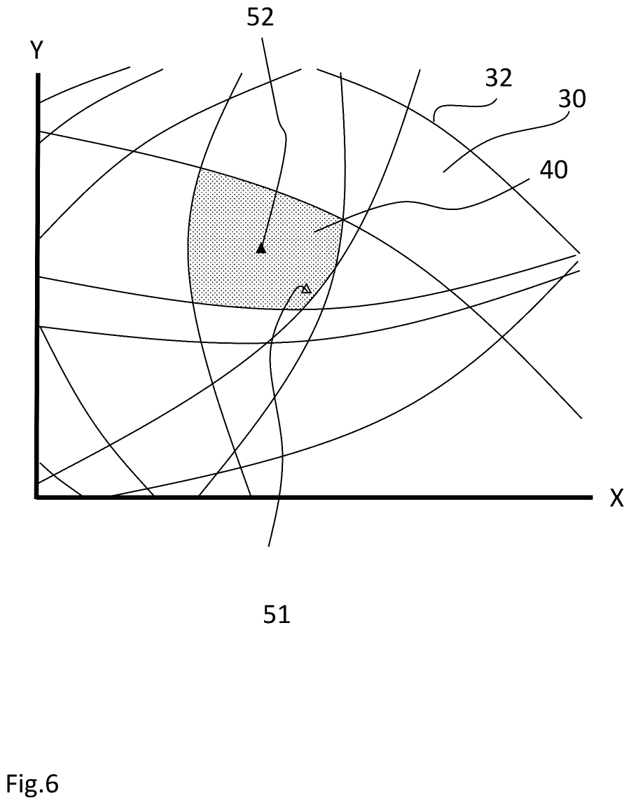

FIG. 6 shows schematically on-earth footprints 30 of satellite beam signals 20 of multiple satellites 10 configured to transmit multiple satellite beam signals 20 in respective signal patterns in X-and Y-coordinates. The user terminal 50 is located in position 51. The user terminal 50 receives multiple satellite beam signals 20. The system and method are configured to calculate the on-earth footprints 30 of the received satellite beam signals 20. The on-earth footprints 30 each comprise defined or calculated perimeter 32, as shown in FIG. 6.

Based on the calculated on-earth footprints 30, the overlapped footprint area 40 is calculated. Estimated position of the user terminal 50 is in a center point 52 of the overlapped footprint area 40. The center point 52 of the overlapped footprint area 40 is calculated based on the on-earth footprints 30 of the received satellite beam signals 20.

Accordingly, the system and method of the present invention is configured to determine or calculate the position of the user terminal 50 as a position area, meaning the overlapped footprint area 40, or as a position point, meaning the center point 52 of the overlapped footprint area 40.

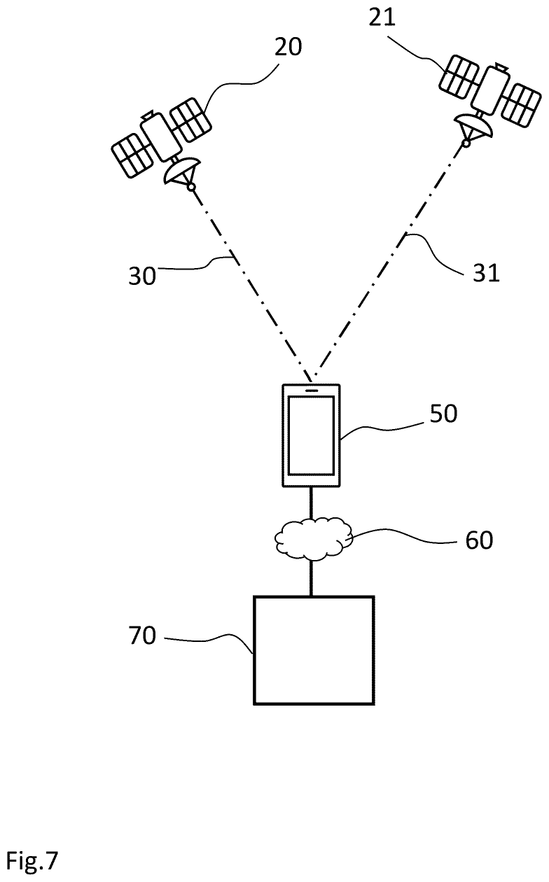

One embodiment of the system of the present invention is shown in FIG. 7. The system comprises the user terminal 50 configured to receive two or more satellite beam signals 20, 21 from one or more satellites 10, 11 simultaneously.

The system further comprises an external server 70 which is provided in data communication connection with the user terminal 50 over a communication network 60. The external server 70 may be any known type of server such as a server device, physical server, distributed server, cloud server or the like. The present invention is not restricted to any type of external server 70.

The communication network 60, for example, may be any one of the Internet, mobile network, a local area network (LAN), or a wide area network (WAN). In addition, the communication network 60 may be implemented by a combination thereof. The present invention is not restricted to any type of communication network.

In the embodiment of FIG. 7, calculations of the on-earth footprint 30, 31 and the calculation of the overlapped footprint area 40 may be carried out in the user terminal 50 or in the external server 70, or the calculations may be distributed in any way between the user terminal 50 and the external server 70.

In the embodiment of FIG. 7, the satellite database may be provided in the user terminal 50 or in the external server 70, or the satellite database may be distributed in any way between the user terminal 50 and the external server 70.

Utilizing the external server 70 provides an online system which utilizes the communication network 60.

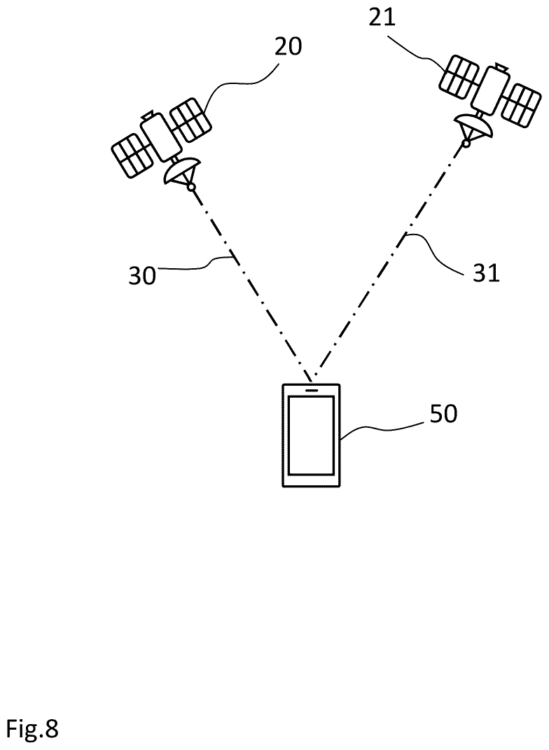

Another embodiment of the system of the present invention is shown in FIG. 8. The system comprises the user terminal 50 configured to receive two or more satellite beam signals 20, 21 from one or more satellites 10, 11 simultaneously.

The embodiment of FIG. 8 is a standalone or an offline system.

In the embodiment of FIG. 8, calculations of the on-earth footprint 30, 31 and the calculation of the overlapped footprint area 40 are carried out in the user terminal 50.

In the embodiment of FIG. 8, the satellite database is also provided in the user terminal 50. Accordingly, the position of the user terminal 50 is determined by the user terminal 50 based on the received satellite beam signals 20,21.

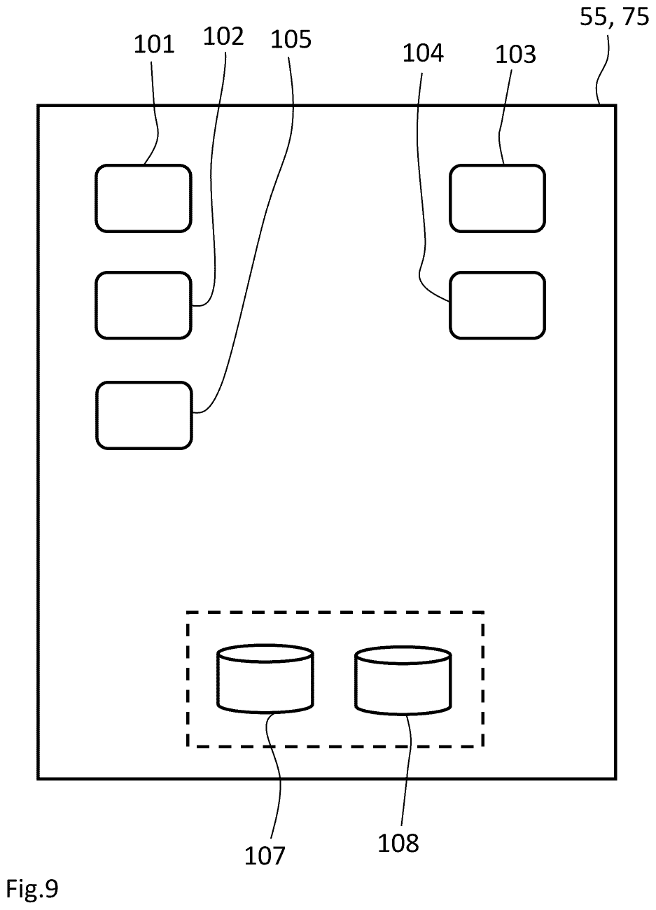

FIG. 9 is a schematic configuration example of a software component which operates on the user device 50, or on the external server 70, or on the user device 50 and on the external server 70. Accordingly, the software component 55 is provided to the user terminal 50, or the software component 75 is provided to the external sever 70. Alternatively, the software component is a distributed software component 55, 65, which is distributed in any manner between the user device 50 and the external server 70.

The software component 55, 65 comprises an input unit 101 is configured to receive the satellite beam signals 20, 21,

The software component 55, 65 further comprises a footprint calculation unit 102 configured to on-earth footprints of the satellite beam signals. The footprint calculation unit 102 comprises the footprint calculation model.

The software component 55, 65 further comprises a position calculation unit 103 configured to calculate the overlapped footprint area 40 or the focused overlapped area 41. The position calculation unit 103 comprises the position calculation model.

The position calculation unit 103 is further configured to calculate the focused position 54 of the user terminal 50.

The software component 55, 65 further comprises a feedback generation unit 104 configured to generate position information based on the overlapped footprint area 40 or the focused overlapped area 41, and/or the focused position 54 of the user terminal 50. The position information comprising geographical coordinates of the overlapped footprint area 40 or the focused overlapped area 41, and/or the focused position 54 of the user terminal 50.

The feedback generation unit 104 is further configured to generate a visual representation of the position information.

The software component 55, 65 further comprises an output unit 105 configured to provide the position information and/or the visual representation of the position information to the user terminal 50 or on a display of the user terminal 50.

The software component 55, 65 comprises a dynamic database 107 configured to store dynamic satellite-to-earth-geometry data.

The software component 55, 65 comprises a static database 108 configured to store static satellite-to-earth-geometry data.

It should be noted that the dynamic database 107 and the static database 108 may also be provided as one satellite-to-earth-geometry database.

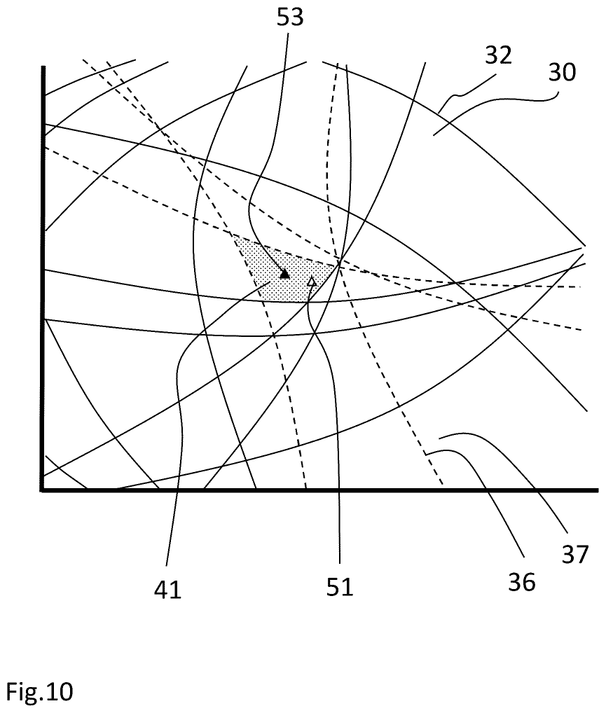

In some embodiments, the positioning accuracy of the method and system is enhanced such that a focused overlapped footprint area 41 may be calculated, as shown in FIG. 10. FIG. 10 discloses the same embodiment as FIG. 6.

As shown in FIGS. 6 and 10, the on-earth footprint areas 30 of the received satellite beam signals 20 have defined perimeters 32 shown with solid lines. The satellites 10 from which at least one satellite beam signals 20 are received in the suer terminal 50 transmit further satellite beam signals which are not received in the user terminal 50 as the user terminal 50 is not within coverage area of these further satellite beam signals. However, as the satellites 10 from which at least one satellite beam signals 20 are received in the user terminal 50 are identified based on the unique beam identifiers, also data of the further satellites beam signals can be acquired from the satellite-to-earth-geometry data.

Therefore, the method may comprise calculating on-earth footprints of further satellite beam signals which are not received in the user terminal 50. At least some of the further on-earth footprint areas of the satellite beam signals which are not received in the user terminal 50 may overlap with the calculated overlapped footprint area 40. Therefore, the overlapped footprint area 40 may be decreased by subtracting from the overlapped footprint area 40 the on-earth footprints of the identified satellites which correspond the non-received satellite beam signals.

Perimeters 36 of the on-earth footprint areas 37 of the non-received satellite beam signals are shown with dotted lines in FIG. 10. As may be seen be by comparing FIGS. 6 and 10, subtracting from the overlapped footprint area 40 the on-earth footprints of the identified satellites which correspond the non-received satellite beam signals has decreased the are in which the user terminal 50 is. Thus, a focused overlapped footprint area 41 is defined. Estimated position of the user terminal 50 is in a centre point 53 of the focused overlapped footprint area 41. The centre point 523 of the overlapped footprint area 40 is calculated based on the on-earth footprints 30 of the received and non-received satellite beam signals 20 defining the focused overlapped footprint area 41.

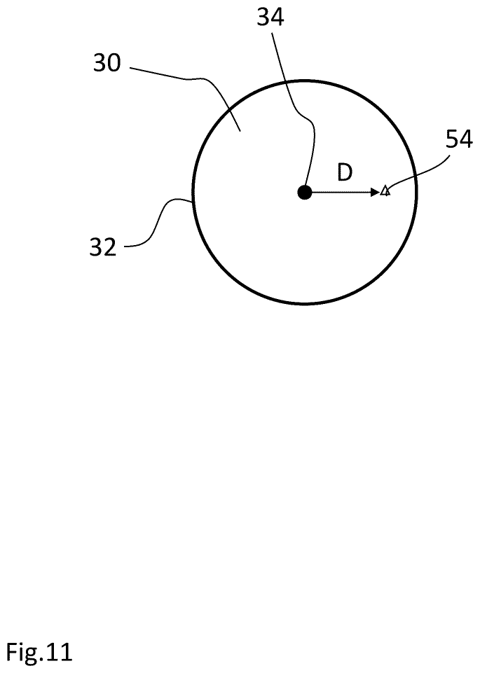

The position accuracy may also be enhanced by utilizing signal strengths of the received satellite beam signals. As mentioned above, calculating the on-earth footprints 30 of the received satellite beam signals 20 comprises calculating the perimeters 32 of the on-earth footprint areas 30, as shown in FIG. 11. Calculating the on-earth footprints 30 of the received satellite beam signals 20 further comprises calculating the centre points 34 of the on-earth footprints 30. Accordingly, the on-earth footprints 30 define the perimeters 32 and the centre points 34 of the on-earth footprints 30.

The satellite-to-earth-geometry data comprises signal strength data which comprises outputted signal strength or calculated maximum received signal strength for each satellite beam signal transmitted form the satellite. The calculated maximum received signal strength may be for each location of the satellite in the orbit. Thus, the calculated maximum received signal strength is associated with ephemeris.

In some embodiments, the method and system are configured to calculate signal strength in the centre point 34 of each of the on-earth footprints 30. Alternatively, the maximum received signal strength is utilized as the signal strength in the centre point 34 of the on-earth footprints 30.

The signal strength is highest at the centre point 34 of the on-earth footprint 30. The signal strength decreases as function of distance from the centre point 34 of the on-earth footprint 30 towards the perimeter 32 of the on-earth footprint 30. Outside the perimeter 32 the signal strength is zero. Therefore, the position of the user terminal 50 in relation to the centre point 34 of each of the on-earth footprints 30 of the received satellite beam signals is configured to be calculated.

The user terminal 50 is configured determined or measure signal strength of each of the received satellite beam signals 20.

Accordingly, the method and system of the present invention comprises calculating distance D of the user terminal 50 from the centre point 34 of the footprints 30 of the received satellite beam signals 20 for determining a focused position 54 of the user terminal 50 inside the overlapped footprint area 40 or inside the focused overlapped footprint area 41, as shown in FIG. 11.

The focused position 54 of the user terminal 50 in relation to the centre points 34 of the on-earth footprints 30 of the received satellite beam signals 20 is calculated by utilizing the outputted signal strength or calculated maximum received signal strength of the satellite beam signals 20 and the measured signal strength of each of the received satellite beam signals 20. Therefore, the position of the user terminal within the inside the overlapped footprint area 40 or inside the focused overlapped footprint area 41 is calculated in relation to the distance from the centre points 34 of the on-earth footprints 30 of the received satellite beam signals 20.

The invention has been described above with reference to the examples shown in the figures. However, the invention is in no way restricted to the above examples but may vary within the scope of the claims.

1. A method for positioning comprising:
receiving two or more satellite beam signals from one or more satellites in a user terminal, each of the received two or more satellite beam signals comprising a unique beam identifier,
identifying the two or more satellites from which the two or more satellite beam signals are received based on the unique beam identifiers,
acquiring satellite-to-earth-geometry data of the identified one or more satellites, the satellite-to-earth-geometry data comprising satellite location and direction information in time-domain,
calculating on-earth footprints of the received two or more satellite beam signals based on the satellite-to-earth-geometry data of the identified one or more satellites, the on-earth footprints comprising location information of the on-earth footprints,
calculating position of the user terminal based on the on-earth footprints of the received two or more satellite beam signals, the position of the user terminal being defined in an overlapped footprint area of the calculated on-earth footprints of the received two or more satellite beam signals, and estimating position of the user terminal inside the overlapped footprint area based on:
the satellite beam signals of the identified satellites; or
the beam pattern data; or
the antenna attributes data; or
the antenna attributes data and the beam pattern data;
wherein the method further comprises:
calculating on-earth footprints of all satellite beam signals of the identified one or more satellites based on the satellite-to-earth-geometry data,
calculating the overlapped footprint area of the calculated on-earth footprints of the received two or more satellite beam signals, and
calculating a focused overlapped footprint area by subtracting from the overlapped footprint area the on-earth footprints of the identified one or more satellites which corresponds one or more non-received satellite beam signals; or
calculating the overlapped footprint area of the calculated on-earth footprints of the received two or more satellite beam signals,
calculating one or more adjacent on-earth footprints of one or more adjacent non-received satellite beam signals of the identified one or more satellites based on the satellite-to-earth-geometry data, the one or more adjacent satellite beam signals are configured to generate the one or more adjacent on-earth footprints which overlap at least partly with the one or more on-earth footprints configured to form the overlapped footprint area, and
calculating a focused overlapped footprint area by subtracting the one or more adjacent on-earth footprints of the identified one or more satellites which correspond the one or more non-received satellite beam signals.

2. The method according to claim 1, wherein at least one of the satellite beam signals is received from a satellite configured to transmit single satellite beam signal, and that the two or more satellite beam signals are received from at least two separate satellites.

3. The method according to claim 1, wherein least one of the satellite beam signals is received from a satellite configured to transmit multiple satellite beam signals in a beam pattern.

4. The method according to claim 3, wherein
the two or more satellite beam signals are received from a single satellite configured to transmit multiple satellite beam signals in the beam pattern, the beam pattern of the satellite comprising two or more two or more satellite beam signals having at least partly overlapped on-earth footprints; or
the two or more satellite beam signals are received from at least two separate satellites.

5. The method according to claim 1, wherein the one or more satellite beam signals are received from one or more Low Earth Orbit satellites.

6. A The method according to claim 1, wherein acquiring the satellite-to-earth-geometry data of the identified one or more satellites comprises:
acquiring the satellite-to-earth-geometry data from the identified satellites based on the unique beam identifiers of the received the one or more satellite beam signals; or
acquiring the satellite-to-earth-geometry data from an external satellite database of an external server based on the unique beam identifiers of the received the two or more satellite beam signals; or
acquiring the satellite-to-earth-geometry data from an internal satellite database of the user terminal based on the unique beam identifiers of the received the two or more satellite beam signals.

7. The method according to claim 1, wherein the satellite-to-earth-geometry data comprises dynamic data comprising satellite ephemeris data, or satellite ephemeris data and satellite orientation data, and calculating the on-earth footprints of the received one or more satellite beam signals is carried out by utilizing the dynamic data of satellite-to-earth-geometry data.

8. The method according to claim 7, wherein the satellite-to-earth-geometry data comprises static data comprising satellite antenna attributes data and the beam pattern data, and calculating the on-earth footprints of the received one or more satellite beam signals is carried out by utilizing the dynamic data and the static data of satellite-to-earth-geometry data.

9. The method according to claim 1, wherein calculating position of the user terminal based on the on-earth footprints of the received one or more satellite beam signals comprises calculating the overlapped footprint area of the calculated on-earth footprints of the received one or more satellite beam signals

10. The method according to claim 1, wherein the method comprises:
acquiring maximum signal strengths of the one or more received satellite beam signals from the static data of satellite-to-earth-geometry data,
calculating a centre point location of the one or more on-earth footprints of the one or more received satellite beam signals the maximum signal strength of each received satellite beam signal being at the centre point of the corresponding on-earth footprint
determining signal strengths of the one or more received satellite beam signals
calculating a focused position of the user terminal inside the overlapped footprint area or the focused overlapped footprint area based on the maximum signal strengths and the determined signal strengths of the one or more received satellite beam signals.

11. A system for positioning comprising,
a user terminal configured to receive one or more satellite beam signals simultaneously from one or more satellites, each of the received one or more satellite beam signals comprising a unique beam identifier, and
a positioning module configured to
identify the one or more satellites from which the two or more satellite beam signals are received based on the unique beam identifiers,
acquire satellite-to-earth-geometry data of the identified two or more satellites from a satellite database, the satellite-to-earth-geometry data comprising satellite location and direction information in time-domain,
calculate on-earth footprints of the received two or more satellite beam signals based on the satellite-to-earth-geometry data of the identified one or more satellites, the on-earth footprints comprising location information of the on-earth footprints,
calculate position of the user terminal based on the on-earth footprints of the received two or more satellite beam signals, the position of the user terminal being defined in an overlapped footprint area of the calculated on-earth footprints of the received two or more satellite beam signals, and
estimate position of the user terminal inside the overlapped footprint area based on:
the satellite beam signals of the identified satellites or
the beam pattern data; or
the antenna attributes data; or
the antenna attributes data and the beam pattern data;
wherein the positioning module is further configured to:
calculate on-earth footprints of all satellite beam signals of the identified one or more satellites based on the satellite-to-earth-geometry data,
calculate the overlapped footprint area of the calculated on-earth footprints of the received two or more satellite beam signals, and
calculate a focused overlapped footprint area by subtracting from the overlapped footprint area the on-earth footprints of the identified one or more satellites which corresponds one or more non-received satellite beam signals, or
calculate the overlapped footprint area of the calculated on-earth footprints of the received two or more satellite beam signals
calculate one or more adjacent on-earth footprints of one or more adjacent non-received satellite beam signals of the identified one or more satellites based on the satellite-to-earth-geometry data, the one or more adjacent satellite beam signals are configured to generate the one or more adjacent on-earth footprints which overlap at least partly with the one or more on-earth footprints configured to form the overlapped footprint area and
calculate a focused overlapped footprint area by subtracting the one or more adjacent on-earth footprints of the identified one or more satellites which correspond the one or more non-received satellite beam signals.

12. The system according to claim 11, wherein
the user terminal comprises a satellite signal receiver; or
the user terminal is a mobile user terminal comprising a satellite signal receiver; or
the user terminal is a mobile user device or a wearable user device comprising a satellite signal receiver.

13. The system according to claim 11, wherein the at least one of the one or more satellites comprises a single-output antenna configured to transmit single satellite beam signal.

14. The system according to claim 11, wherein the at least one of the one or more satellites comprises a multiple-output antenna configured to transmit multiple satellite beam signals in a beam pattern.

15. The system according to claim 11, wherein the two or more satellite beam signals are received from one or more Low Earth Orbit satellites.

16. The system according to claim 11, wherein the system is configured to carry out a method according for positioning, wherein the method comprises:
receiving two or more satellite beam signals from one or more satellites in a user terminal, each of the received two or more satellite beam signals comprising a unique beam identifier,
identifying the two or more satellites from which the two or more satellite beam signals are received based on the unique beam identifiers,
acquiring satellite-to-earth-geometry data of the identified one or more satellites, the satellite-to-earth-geometry data comprising satellite location and direction information in time-domain,
calculating on-earth footprints of the received two or more satellite beam signals based on the satellite-to-earth-geometry data of the identified one or more satellites, the on-earth footprints comprising location information of the on-earth footprints,
calculating position of the user terminal based on the on-earth footprints of the received two or more satellite beam signals, the position of the user terminal being defined in an overlapped footprint area of the calculated on-earth footprints of the received two or more satellite beam signals, and estimating position of the user terminal inside the overlapped footprint area based on:
the satellite beam signals of the identified satellites; or
the beam pattern data; or
the antenna attributes data; or the antenna attributes data and the beam pattern data;
wherein the method further comprises:
calculating on-earth footprints of all satellite beam signals of the identified one or more satellites based on the satellite-to-earth-geometry data,
calculating the overlapped footprint area of the calculated on-earth footprints of the received two or more satellite beam signals, and
calculating a focused overlapped footprint area by subtracting from the overlapped footprint area the on-earth footprints of the identified one or more satellites which corresponds one or more non-received satellite beam signals; or
calculating the overlapped footprint area of the calculated on-earth footprints of the received two or more satellite beam signals,
calculating one or more adjacent on-earth footprints of one or more adjacent non-received satellite beam signals of the identified one or more satellites based on the satellite-to-earth-geometry data, the one or more adjacent satellite beam signals are configured to generate the one or more adjacent on-earth footprints which overlap at least partly with the one or more on-earth footprints configured to form the overlapped footprint area, and
calculating a focused overlapped footprint area by subtracting the one or more adjacent on-earth footprints of the identified one or more satellites which correspond the one or more non-received satellite beam signals.
